(19) United States
(12) Patent Application Publication
(10) Pub. No.: US 2012/0176767 A1
(43) Pub. Date: Jul. 12, 2012

(54) LED WORK LIGHT HAVING ADJUSTABLE OUTPUT

(75) Inventors: Robert Tod Whitfield, Toronto (CA); Donald L. Klipstein, Upper Darby, PA (US); Jack Brass, Toronto (CA)

(73) Assignee: Brasscorp Limited, North York (CA)

(21) Appl. No.: 13/230,394

(22) Filed: Sep. 12, 2011

Related U.S. Application Data
(60) Provisional application No. 61/403,289, filed on Sep. 12, 2010.

(51) Int. Cl. F21V 19/02; F21V 29/00

(52) U.S. Cl. 362/33

(57) ABSTRACT

An LED work light, having a housing comprising a head section, and a foot section and a handle section each connected by hinges between the head section and the handle section and between the handle section and the foot section. The head section and foot section are hinged about the handle section by hinge means. Light is produced by one or more LEDs in the head section. Knobs are used to continuously adjust between magnitude of overall light output and excess-vs-insufficiency of red spectral content in the light produced by the LED work light. Magnitude of light produced is selected by choice of pushbuttons. Heat produced by LEDs and dissipated into the head section can be conducted from the head section to the handle section by the hinge means used to connect the head section to the handle section.

### CROSS-REFERENCE TO RELATED APPLICATIONS

This application claims the benefit of priority, under 35 U.S.C.§119(e), to U.S. Provisional Application No. 61/403,289, filed Sep. 12, 2010, the content of which is hereby incorporated by reference herein in its entirety. This application is related to Canadian Patent Application No. ______ , filed Sep. 12, 2011, under title LED WORK LIGHT HAVING ADJUSTABLE OUTPUT.

### TECHNICAL FIELD

This description is related to the general field of LED work lights, and in particular to the structure and driving circuitry for such work lights.

### BACKGROUND

Many modern work lights utilize LEDs. Some LED work lights provide plastic hooks for positioning the lamps. LEDs available for use in work lights are becoming brighter over time. The resulting LED work lights provide stronger illumination in the available spectrum for improved performance. LEDs generate quite a bit of heat and work lights are often provided with heat sinks to cool the LEDs for improved performance.

Improvements or alternatives to current devices and methods utilized for LED lamps are desirable.

### SUMMARY

In a first aspect embodiments provide an LED work light. The LED work light has a housing with a head section, and a foot section and a handle section each connected by hinges between the head section and the handle section and between the handle section and the foot section. The head section and foot section are hinged about the handle section by hinge means, and light is produced by one or more LEDs in the head section.

The LED work light may have means of attachment to a magnetic surface in an area that the LED work light can be attached to if temporarily, by means of a magnet in its foot section. The LED work light may have a hook that is attached to the handle section. The hook may be attached to the handle section by a ball and socket joint.

The LED work light may have means to adjust quantity of light produced by the one or more LEDs in its head section. The LED work light may have its total light output being adjustable between maximum and a lower level. The LED work light may have its total light output being selectable via pushbuttons between two levels via pushbuttons. The LED work light may have means to adjust color rendering properties. The adjustment in color rendering may be among magnitudes of excess and insufficiency of red spectral content in comparison to a blackbody radiator of same correlated color temperature of the light in question produced by the LED work light. The LED work light may have means to adjust the quantity of light produced but lack means of adjustment in color rendering or overall color. The LED work light may have brightness of light adjustable continuously. The LED work light may have continuously adjustable quantity of light output achievable from one or more knobs. The LED work light may have only one knob at least essentially adjust overall light output magnitude. The LED work light may have two knobs used to continuously adjust between magnitude of overall light output and excess-vs-insufficiency of red spectral content in the light produced by the LED work light.

The LED work light may have magnitude of light produced selectable by choice of three pushbuttons comprising “high”, “low”, and “off”. “low” may accomplish significantly less than half as much light output as “high” achieves. “low” may result in at least half as much light output as “high” achieves. The LED work light may have a ratio of “low” to “high” outputs that is adjustable.

Heat produced by the one or more LEDs in the LED work light and dissipated into the head section may be conducted from the head section to the handle section by the hinge means used to connect the head section to the handle section.

Other aspects and additional or alternative embodiments of the above aspects, including for example methods of use, will be evident from the further description and the drawings herein.

### BRIEF DESCRIPTION OF THE DRAWINGS

For a better understanding of the present invention and to show more were clearly how it may be carried into effect, reference will now be made, by way of example, to the accompanying drawings which show the preferred embodiment of the present invention and in which:

FIG. 1 is a perspective view of an embodiment of an adjustable LED work light, and

FIG. 2 is a perspective view of an alternate embodiment of an adjustable LED work light.

### DETAILED DESCRIPTION

Within this specification, LED refers to “light emitting diode” or an “LED component” having one or more light emitting diode chips.

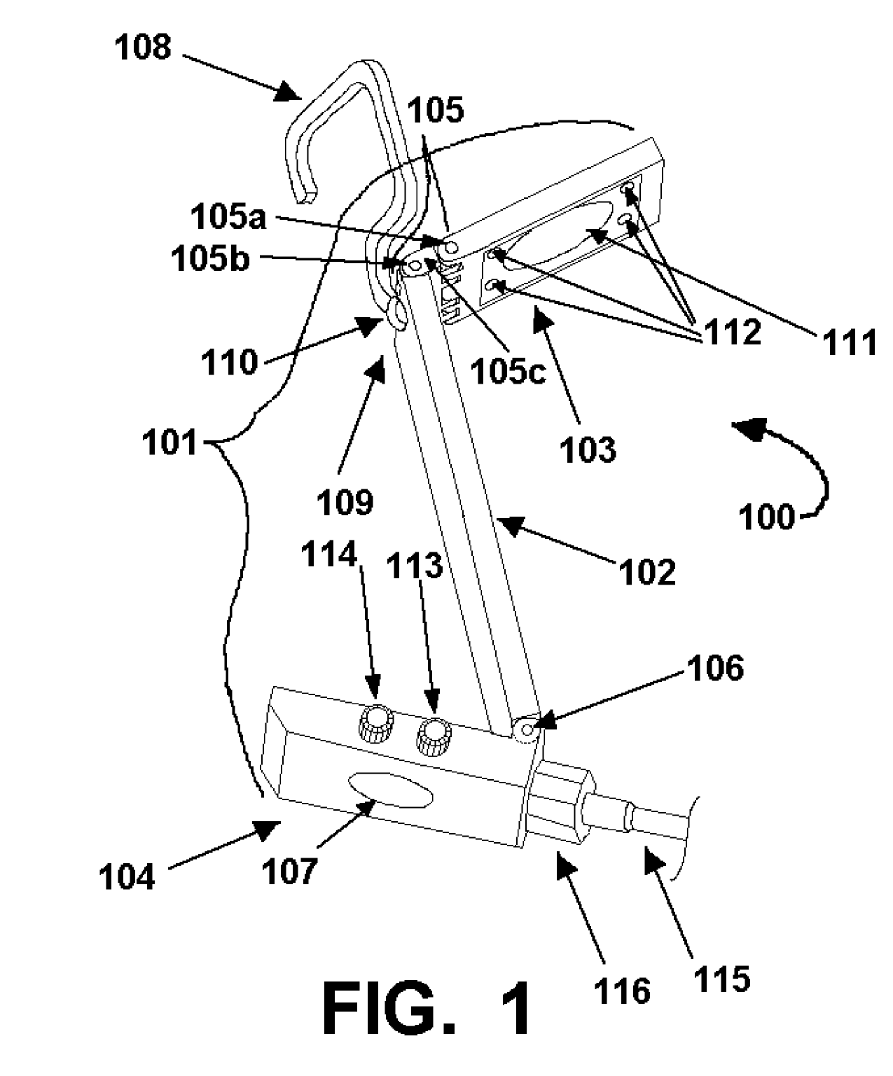

Referring to FIG. 1, an adjustable LED work light 100 is shown as having a multiply hinged housing 101 comprising a handle section 102, a head section 103, and a foot section 104. The head section 103 is connected to the handle section 102 by a head hinge assembly 105 comprising a pair of hinge pins 105a, 105b and an interhinge piece 105c. The hinge assembly 105 permits the head section 103 to be swiveled up and down if the handle section 102 is held vertically. This permits users of the LED work light 100 not to be restricted to a particular hand orientation in order to illuminate a particular area from a particular direction. As a result, the LED work light 100 will sometimes be more comfortable to use than one lacking the hinge assembly 105 or other swiveling means.

Alternatively, the hinge assembly 105 may comprise a single hinge rather than two hinges. However, a usefully great range of positioning of the head section 103 with respect to the handle section 102 has been accomplished in a preferred embodiment by having the hinge assembly 105 comprising two hinges.

The foot section 104 can be swiveled with respect to the handle section 102 by means of a hinge between these two sections including a hinge pin 106.

The foot section 104 includes a magnet 107, which can be used for temporarily attaching the adjustable LED work light 100 to magnetic surfaces, including ferrous automobile parts such as the lower surface of the hood of most automobiles. Since the foot section 104 and accordingly the entire adjustable LED work light 100 can be rotated about an axis perpendicular to the foot section 104 and its magnet 107, and since a hinge 106 exists between the foot section 104 and the handle section 102, and a hinge assembly exists between the head section 103 and the handle section 102, the head section 103 can be aimed to face in a wide variety of directions with respect to a surface that the foot section 104 is temporarily attached to.

Alternatively, the adjustable LED work light 100 can be handheld, preferably by holding it by its handle section 101.

Further alternatively, the LED work light 101 is shown as further having a hook 108 that is attached to the handle section 102 by means as shown of a ball and socket joint 109 including a ball 110 that is part of the hook 108.

The adjustable LED work light furthermore can be placed in a wide variety of positions since it has both the magnet 107 and the hook 108. In many situations, the adjustable LED work light 100 can have its magnet 107 attached to a magnetic surface, while its hook 108 can be attached to a nearby suitable object such as a nearby cable, wire, hose or pipe. Accordingly in such situations, the adjustable LED work light can be temporarily mounted in a work area with its handle section 102 having some freedom of positioning as permitted by choice of location to place the magnet 107 and the hook 108, along with ability to move the handle section 102 with respect to the hook 108 and the magnet 107 in the foot section 104, and furthermore according to ability to rotate the adjustable LED work light 100 about an axis perpendicular to the foot section 104 and its magnet 107. With such available variety of positions in temporarily mounting the LED work light 100, its head section 103 can be swiveled with respect to its handle section 102 when the LED work light 100 is temporarily mounted to a suitable object or objects via its magnet 107 and its hook 108.

One application where increased user comfort is beneficial is in illuminating under-dash areas of an automobile, which often requires a user of an illumination source to work in uncomfortable body positions. Reducing body discomfort of a person working under the dashboard allows that person to be less distracted by body discomfort. This has the benefit of increasing productivity and reducing the rates at which errors and worker accidents occur.

The adjustable LED work light 100 is shown able to receive electrical power via a cable 116 that is removable and attached by a nut-like connector housing 117. The foot section 104 is allowed to rotate about the cable 116 by the nut-like connector housing 117, which fits loosely over a rotatable plug (not shown due to being hidden by the nut-like connector housing) that the cable 116 is terminated with. The plug (not shown) is received by a jack (not shown due to being hidden by the nut-like connector housing 117) in the foot section 104.

The adjustable LED work light 100 is shown as having one or more main LEDs 111 and one or more supplementary LEDs 112 disposed in its head section 103. The one or more main LEDs 111 are preferably white LEDs having a color rendering index in the range of 60 to 75 and having a spectrum with less red content than that of blackbody radiation of overall color closest to that of the one or more main LEDs 111.

The one or more main LEDs 111 may be one or more single chip LEDs, multichip LEDs, or LED arrays packaged as LED components. In one preferred embodiment of the adjustable LED work light 100, the one or more main LEDs 111 is a single LED component having an array of 100 LED chips.

The one or more main LEDs 111 are preferably mounted to the head section 103 in a way favoring dissipating heat from the one or more main LEDs 111, such as having the one or more main LEDs 111 being mounted to the head section 103 in a way that conducts heat from the one or more main LEDs 111 to the head section 103. Along such lines, the head section 103 of the housing 101 is preferably made of metal such as aluminum.

Preferably, furthermore the hinge assembly 105 and the handle section 102 are arranged to favor dissipation of heat from the head section 103 to the handle section 102, so that both the head section 103 and the handle section 102 can both sufficiently dissipate heat from the LEDs 111, 112 to the ambient environment such as to achieve heat dissipation means beyond that alone of the portion of the housing 101 that is in the head section 103. Furthermore, the handle section 102 may transfer some heat to the foot section 104 through the hinge that includes the hinge pin 106. The handle section 102, head section 103, foot section 104, and hinge piece 105 are preferably shaped with interleaving shapes so as to favor conduction of heat from the head section 203. The hinged housing parts are preferably anodized or painted to improve radiation of heat in comparison to use of bare metal.

Furthermore, the handle section 102 can be joined to the foot section 104 to further dissipate heat from the LEDs 111,112 into and outward from a preferably metallic part of the housing 101 used to house the foot section 104.

The one or more supplementary LEDs 112 preferably have a spectrum that is rich in red light. Preferably, several low power LEDs are used as the supplementary LEDs 112. The supplementary LEDs 112 may be a combination of red, green and blue LEDs whose light outputs combine to form light that is similar in overall color to that produced by the one or more main LEDs 111. Such a combination of red, green and blue LEDs in the supplementary LEDs 112 would preferably have a spectrum that has excessive red light content in comparison to a blackbody radiator. The one or more supplementary LEDs 112 may be LED components that have within each at least one LED chip of each of the three colors red, green and blue.

The LED work light 100 is also shown as having a brightness adjustment knob 113 and a spectrum knob 114. Preferably, the brightness adjustment knob 113 controls the total light output of the LED work light 100. The spectrum adjustment knob 114 preferably controls the ratio of output from the one or more supplementary LEDs 112 to the output from the one or more main LEDs 111. In one preferred embodiment of the LED work light 100, the range of adjustment is approximately having 0-50% of the total light output being from the one or more supplementary LEDs 112 and approximately 50-100% of the total light output being from the one or more main LEDs 111.

The LED work light 100 may alternatively be constructed to have the brightness adjustment knob 113 controlling the output of the one or more main LEDs 111 and the spectrum adjustment knob 114 controlling the output of the one or more supplementary LEDs 112 independently of each other.

Adjustment of preferably knob 114 alone as a spectrum adjustment knob, or alternatively both knobs 113 and 114, adjusts the magnitude of deficiency or excess of red spectral content in the light produced by the adjustable LED work light 100. This deficiency or excess is in comparison to a blackbody radiator producing light as close in color as possible to that of the adjustable LED work light 100. This means that the adjustable LED work light has adjustable color rendering properties.

It is anticipated that different users of the LED work light 100 will differ in their preferences of adjustment of the color rendering properties of the LED work light 100. For example, it is anticipated that some users of the LED work light 100 will want it adjusted to have its color rendering properties as close as possible to those of sunlight. Alternatively, some users have a liking to the color rendering properties typical of most white LEDs and fluorescent lamps that have color rendering index in the range of 60-75 and a spectrum that has a deficiency of red spectral content in comparison to a blackbody radiator of nearest overall color. Such a red-deficient spectrum is beneficial to some persons by increasing the difference in darkness between red objects and orange objects. It is common for persons to see differences in darkness or brightness of objects more easily than to see color differences, especially when the objects are small in size, even in the case of persons with normal color vision.

Furthermore, several percent of men have one of the color vision deficiencies of protanopia, deuteranopia, protanomaly, or deuteranomaly. Protanopia and deuteranopia are the two forms of red-green color blindness. Protanopia in addition involves seeing red objects as darker or dimmer than a person with normal color vision would, while deuteranopia causes red objects to appear slightly lighter or brighter than they would to a person with normal color vision. Protanomaly and deuteranomaly are respectively partial forms of protanopia and deuteranopia. Users of the LED work light 100 can benefit from adjusting its color rendering properties to better discern the color of colored objects, such as colored wires and color coding on color coded electronic components such as most non-surface-mount resistors.

Even among users of the LED work light 100 that have normal color vision, some of such users will benefit from adjustability of the color rendering properties of the LED work light 100. For example, discernment of the nominal color of an object that has experienced color fading or discoloration by contamination that is not convenient to remove, such as an old cloth-insulated wire that has experienced color fading, is easily assisted by varying the color rendition properties of the LED work light 100.

The LED work light 100 is not only adjustable in color rendering properties via its knobs 113 and 114, but also adjustable in brightness.

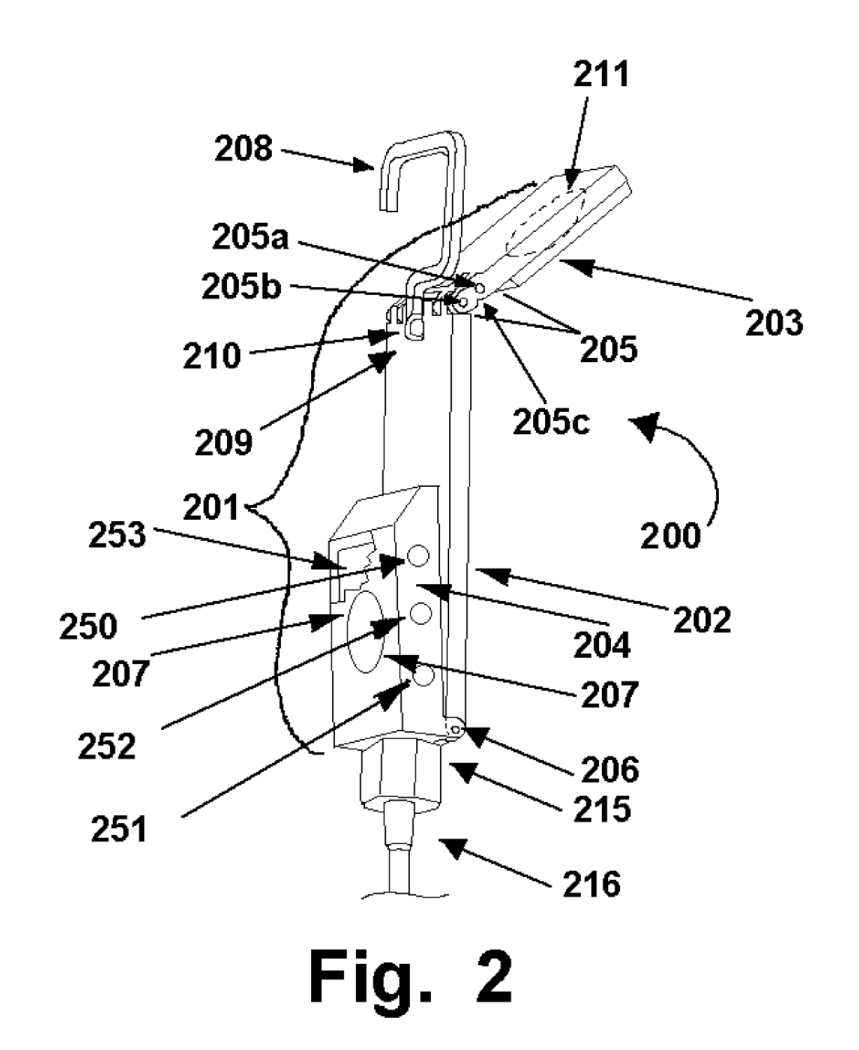

Referring to FIG. 2, an adjustable LED work light 200 is shown, differing from the adjustable LED work light 100 of FIG. 1 in adjustability by having adjustability in quantity of light produced without adjustability in color rendering properties. Otherwise except as noted below, it is shown as being similar to the adjustable LED work light 100 of FIG. 1.

Like the adjustable LED work light 100 of FIG. 1, the adjustable LED work light has a hinged housing 201 comprising a head section 204, a handle section 202, and a foot section 204, with the head section 203 hingeably attached to the handle section 202 via a hinge 205 that comprises a hinge piece 205 and hinge pins 205a, 205b. The handle section 202 is hingeably attached to the foot section 204 via a hinge including a hinge pin 206. The adjustable LED work light 200 has a magnet 207 and a hook 208 that includes a ball 210 that is part of a ball and socket joint 209.

The LED work light 200 benefits from having a brightness adjustment while it lacks the cost of the spectrum adjustment feature that the adjustable LED work light 100 of FIG. 1 has. The LED work light 200 is shown as having only one or more main LEDs 211 and not having any supplementary LEDs. The lack of supplementary LEDs and the lack of color or spectral adjustment can be useful to reduce the production cost of an adjustable LED work light 200 in comparison to the adjustable LED work light 100 of FIG. 1, since the adjustable LED work light 200 has the positioning adjustability and the brightness adjustability of the LED work light 100 of FIG. 1.

Adjustability of light output quantity alone improves usefulness of the LED work light 200 over work lights and flashlights that lack adjustability of light output, or that have limited adjustability of light output such as one fixed degree of dimming Various users of the LED work light 200 or the above LED work light 100 would benefit from a wide range of adjustability of the quantity of light produced by one of these lamps. For example, an automotive service technician working underneath the dashboard of an automobile would prefer to adjust the quantity of light output by an illumination source such as the LED work light 200 or the above LED work light 100 of FIG. 1 to maximize illumination comfort.

Accordingly, the LED work light 200 has one or more white main LEDs as described above for FIG. 1 with reference numeral 111 (not shown due to alternative view in FIG. 2 not showing LEDs), and lack of colored LEDs.

Sometimes, choice of two selectable light output magnitudes in any adjustable LED work light 200 can be more useful than such choice of competitive products if the two available light levels are more suitable than in competing products that provide a choice of two selectable light output magnitudes.

One aspect of viewing comfort involves discernment of colors and fine details in work scenes. Human eyes tend to do this best with higher levels of illumination. However, human vision involves not only the eyes, but also the brain. A person doing a visual task can easily benefit from a magnitude of illumination other than that which optimizes acuity of the eyes alone. One example is of a person whose brain is adapted to a lower illumination level, and who experiences discomfort from experiencing a jolting blast of a higher illumination level even if that person's eyes work better at a higher illumination level.

Some persons maximize their viewing comfort in most to all work situations with higher illumination levels that favor greater visual acuity. Other persons can lose productivity by having illumination level suddenly changing from one that such persons are adapted to, to a greater one that such person's visual systems do not quickly adapt to due to discomfort arising from effort required in the brain to adapt to a change in illumination level.

A specific aspect of viewing comfort, for example in the specific case of an automotive service technician performing under-dash work, is for adjustability of the light output of the LED work light 200 or the above LED work light 100 of FIG. 1 to achieve a personally comfortable balance personally favored by such a worker between illumination of under-dashboard areas by either of the LED work lights 200 or the one 100 of FIG. 1 and ambient light coming through the windows of an automobile that such automotive technician needs to work under the dashboard of. Automobiles that require under dash work may be parked outdoors in bright daylight or may be parked indoors in garages illuminated much less brightly than outdoors in bright daylight.

An aspect of optimizing magnitude of illumination for performing visual tasks involves effects of illumination of only parts of the very wide field of vision that humans normally have. If only a minority of what a person is seeing is illuminated, then that person's vision sometimes adapts as if the same amount of light received by that person's eyes was received more evenly throughout that person's field of vision. That can cause visual processes to partially saturate on brightly-illuminated areas, causing reduced ability to discern colors or fine details with minor difference in lightness or darkness from their surroundings. As a result, persons using an illumination source to illuminate only a minority of what is in their fields of vision often find to be optimal a lower level of illumination than if the illumination presented a sensation of illumination to a majority of such persons' field of vision. One example here is a technician who illuminates only the area that needs to be seen, even if that area is a minority of such technician's field of vision. This example includes a significant fraction of automotive service technicians' under-dashboard work.

Accordingly, the adjustable LED work light 200 is shown as having 2 selectable light output levels via an “off” pushbutton 250, a “high” pushbutton 251, and a “low” pushbutton 252.

One preferred embodiment of the adjustable LED work light 200 has:

Pressing the “off” pushbutton 250 causes the adjustable LED work light 200 to not produce light, regardless of its previous state.

Pressing the “high” pushbutton 251 causes the LED work light 200 to produce maximum light output, regardless of its previous state.

Pressing the “low” pushbutton 252 causes the LED work light 200 to produce light at a magnitude that is a typically a fixed fraction of the maximum that results from pressing the “high” pushbutton 251. Alternatively, an adjustment means may be provided inside or accessibly on the housing 201 so that “low” can be an adjustable fraction of “high”.

The adjustable LED work light 200 typically has circuitry 253 to control the magnitude of current or the magnitude of power consumed by the one or more LEDs.

The circuitry used to accomplish this preferably includes a logic circuit including sequential logic to allow choice of selection between two magnitudes of current or power or a mathematical combination thereof either to be delivered to the main LED 111 or to be consumed from the power source (not shown) that is used to power the adjustable LED work light 200.

Such a logic circuit may be based on a microprocessor. Preferably alternatively, such a logic circuit comprises variants of components that have existed in the 1980's such as the 4027B dual flip-flop IC and the LM339 comparator IC because of their low cost and lack of necessity to achieve a stored program for a microprocessor.

Preferably, the adjustable LED work light 200 has its “low” setting of light output resulting in light output being less than half that resulting from its “high” setting. For example, light output from use of the “low” setting may be 10-30 percent of that of the “high” setting. However, an embodiment may alternatively have the “low” setting resulting in light output equal to at least half that of the “high” setting.

The ratio of light output at the “low” setting to that of the “high” setting may be adjustable by an additional adjustment means (not shown) that is either inside the housing 201 or accessibly placed on the housing 201.

With additional reference to both FIGS. 1 and 2, embodiments of the invention have various means to couple heat dissipation from the head section 103 as described in FIGS. 1 and to the handle section 102 as described in FIGS. 1 and 2.

Embodiments described herein can achieve great flexibility in positioning of an LED work light. For example, the head of the work light can be movable with respect to the body of the work light. As a detailed example, head versus body movement can be accomplished by a closely spaced pair of hinges (105 a and b, or 205 a and b). These hinges may have some ability to conduct heat from the head to the body. In order to conduct heat the body may be made of a suitably heat conductive material such as aluminum, aluminum alloy, zinc alloy, or copper alloy.

Embodiments described herein can provide adjustable level of supplemental LEDs such as red ones to adjust color rendering properties. In addition or alternatively, embodiments described herein can provide convenient adjustment of LED output. This is particularly useful where maximum available output may be uncomfortably bright in some situations.

Any embodiments of the invention can be found useful for purposes that LED work lights have been used for.

Various embodiments of the invention are anticipated to be advantageous for use as work lights in ways enabled by features that are in any combination of specific features described above, including any combination of features of more than one of the above embodiments including above-described alternatives of any of the above-described embodiments.

What is claimed is:

1. An LED work light, having a housing comprising a head section, and a foot section and a handle section each connected by hinges between the head section and the handle section and between the handle section and the foot section, wherein the head section and foot section are hinged about the handle section by hinge means, and furthermore where light is produced by one or more LEDs in the head section.

2. The LED work light of claim 1, further having means of attachment to a magnetic surface in an area that the LED work light can be attached to if temporarily, by means of a magnet in its foot section.

3. The LED work light of claim 1, furthermore having a hook that is attached to the handle section.

4. The LED work light of claim 3, wherein the hook is attached to the handle section by a ball and socket joint.

5. The LED work light of claim 1 further having means to adjust quantity of light produced by the one or more LEDs in its head section.

6. The LED work light of claim 5, having its total light output being adjustable between maximum and a lower level.

7. The LED work light of claim 5, having its total light output being selectable via pushbuttons between two levels via pushbuttons.

8. The LED work light of claim 5, further having means to adjust color rendering properties.

9. The LED work light of claim 8, wherein the adjustment in color rendering is among magnitudes of excess and insufficiency of red spectral content in comparison to a blackbody radiator of same correlated color temperature of the light in question produced by the LED work light.

10. The LED work light of claim 5, wherein the LED work light has means to adjust the quantity of light produced but lacks means of adjustment in color rendering or overall color.

11. The LED work light of claim 10, when brightness of light produced therefrom is adjustable continuously.

12. The LED work light of claim 11, when continuously adjustable quantity of light output therefrom is achievable from one or more knobs.

13. The LED work light of claim 12, when only 1 knob at least essentially adjusts overall light output magnitude.

14. The LED work light of claim 12, where 2 knobs are used to continuously adjust between magnitude of overall light output and excess-vs-insufficiency of red spectral content in the light produced by the LED work light.

15. The LED work light of claim 6, wherein magnitude of light produced is selected by choice of 3 pushbuttons comprising “high”, “low”, and “off”.

16. The LED work light of claim 15, wherein “low” accomplishes significantly less than half as much light output “high” achieves.

17. The LED work light of claim 15, wherein “low” results in at least half as much light output as “high” achieves.

18. The LED work light of claim 15 wherein the ratio of “low” to “high” outputs is adjustable.

19. The LED work light of claim 1, wherein heat produced by the one or more LEDs and dissipated into the head section is conducted from the head section to the handle section by the hinge means used to connect the head section to the handle section.
